(19) United States
(12) Patent Application Publication
(10) Pub. No.: US 2026/0260783 A1
(43) Pub. Date: Sep. 3, 2026

(54) Electric Power Harness for An Aircraft

(71) Applicant: SAFRAN ELECTRICAL & POWER, BLAGNAC CEDEX (FR)

(72) Inventors: Jérôme GENOULAZ, BLAGNAC CEDEX (FR); Laurent Pierre François Jules AZEMARD, BLAGNAC CEDEX (FR)

(21) Appl. No.: 18/877,837

(22) PCT Filed: Jun. 9, 2023
(86) PCT No.: PCT/FR2023/050830

§ 371 Date: Dec. 20, 2024

(30) Foreign Application Priority Data
Jun. 22, 2022 (FR) 2206195

(51) Int. Cl. H01B 9/02; B64D 35/022

(52) U.S. Cl. CPC H01B 9/02; B64D 35/022; B64D 2221/00

(57) ABSTRACT

An electric-power harness for aircraft includes a plurality of cables. Each cable has, radially from the inside to the outside, a conducting core, a first layer of semiconductor material, an insulating layer, and a second layer of semiconductor material. The harness further includes a shared shielding placed in electrical contact with the second layers of semiconductor material of each cable.

### FIELD OF THE INVENTION

The invention relates to the field of high electric-power transmission on board an aircraft, particularly in the context of electric or hybrid propulsion. More specifically, the invention relates to an electric harness for this transmission.

### DESCRIPTION OF RELATED ART

High electric-power transmission in an aircraft requires the use of alternating (AC, Alternating Current) or modulated (or PWM, for Pulse Width Modulation) voltage between the rotating machines of the aircraft (electric motor and/or generator) and other aircraft systems, like power converters and distribution network nodes.

The transmission of these high voltages, associated with typical aeronautic constraints (low pressure, high temperatures, high temperature gradients, etc.), requires the use of coaxial, structured power cables, in which an insulator is inserted radially between two layers of semiconductor material (generally an insulator filled with conducting particles).

In everything that follows, the terms longitudinal, transverse and radial are understood relative to the main elongation direction of the cable or cable harness.

FIG. 1 is a cutaway view of such a power cable 1, comprising, radially from the center to the outside, a conducting core 2, a first inner layer 3 of semiconductor material, a first layer of insulating material 4, a second outer layer 5 of semiconductor material, and a shielding layer 6 and a jacket 7 for mechanical protection and/or airtightness.

At least three such cables 1 assembled as a strand, gathered within a harness 10 shown in FIG. 2, are necessary to transmit power in a three-phase AC or PWM system.

The harness 10 further comprises a connection system at each end of the harness, composed of elements providing the electrical contact, electrical insulation, continuity of the shielding and taking up the mechanical and/or airtight protective jacket, as well as a protection against electromagnetic waves, of jacket type or overbraiding in the case of a harness for PWM voltages and a mechanical and/or airtight protection of the jacket or overbraid.

However, testing these cables assembled in harness shows a significant circulation of unwanted current in the shielding, coming from electromagnetic coupling, during operation at high frequency (for example, 1500 Hz). In fact, the current induced in the shielding is proportional to the frequency, which makes this parameter much more critical for high frequency applications than for a typical 50 Hz current.

The problem is that this current circulation in the shielding leads to losses by Joule effect in addition to losses which are generated by the current circulating in the core of the cable, which is the only useful current. This parasitic current also passes by the connector, the electrical interfaces and the equipment case connected to the shielding, also resulting in additional Joule losses in these areas. These areas further are not designed for continuous circulation of current and may be damaged over the long-term.

### BRIEF SUMMARY OF THE INVENTION

The invention aims to remedy these disadvantages. For this purpose, the object of the invention is an electric-power harness for aircraft, comprising a plurality of cables, where each cable comprises, radially from the inside to the outside:
a conducting core;
a first layer of semiconductor material;
an insulating layer; and
a second layer of semiconductor material;
characterized in that the harness further comprises a shared shielding placed in electrical contact with the second layers of semiconductor material of each cable.

Such a harness serves to greatly reduce the induced current circulating in the shielding through the addition of currants of opposite phase induced by each of the cables in the shared shielding, whose resultant is very small or even zero.

The harness may further comprise a protective jacket arranged tightened radially around the shared shielding.

Such a characteristic allows both a good hold of the electrical contact between the shared shielding and the second layers of the cable, and also protection of the harness against extreme conditions.

The shared shielding may be arranged in electrical contact with the second layer of each cable over a substantially equal contact surface for each of the cables.

Such a characteristic serves to further reduce the amplitude of the resultant of the currents induced by each of the cables.

Substantially equal is understood to mean that gaps less than or equal to 10% of the value of said contact surface area are tolerated.

The shared shielding may comprise a single shielding layer placed radially around the cables of the harness.

Such a characteristic allows simply and robustly having a shielding shared by the cables without greatly increasing the mass of the harness.

Each cable may comprise an individual shielding layer, where the individual shielding layers are kept in mutual electrical contact.

Such a characteristic serves to assure that for each cable, the outer semiconductor layer is in contact with the ground reference which is carried by the individual shielding over its entire outer surface.

The shared electrical contact may be held by a protective jacket tightened around the cables. The shared electrical contact may also be held by a shared shielding layer in electrical contact with each of the individual shielding layers.

The cables may be arranged substantially parallel to each other, aligned along a direction perpendicular to their principal elongation direction, where the shared shielding is woven intercrossed around each of the cables.

With such a characteristic, a flat harness for placement in narrow passages is possible.

Electrical resistance of the shielding between two ends of the harness may be included between 0.1 mΩ and 100mΩ, and preferably between 1 mΩ and 20 mΩ and even more preferably between 3 mΩ and 10 mΩ.

Such a characteristic serves to provide an equipotential in the direction of elongation of the harness.

The resistance of the shielding is measured for example by means of an ohmmeter connected near the two ends of the harness. Recall that a milliOhm is equal to 10⁻³Ω.

The outer layers may be made of a semiconductor material having an electrical resistivity included between 10 Ω·m and 100 Ω·m.

Such a characteristic serves to avoid the appearance of radial potential differences in the cables.

Near at least one end of the harness, each cable may comprise an individual shielding layer over an end segment.

The end portion may have a short length, for example under 500 mm.

This characteristic serves to restrict the formation of the resulting induced current of the individual shielding of the cables in said end portion, and thus minimize the resulting impact. This makes a single-channel connection for large diameter cables possible.

### BRIEF DESCRIPTION OF THE DRAWINGS

FIG. 1 is a cutaway view of a power cable for aircraft from the state-of-the-art;

FIG. 2 is a transverse section view of a power harness comprising three cables like the one from FIG. 1;

FIG. 3 is a transverse section view of a power harness according to the invention;

FIG. 4 is a top view of one end of the harness from FIG. 3 allowing a single-channel type connection;

FIG. 5 is a transverse section view of a flattened harness according to a second embodiment of the invention;

FIG. 6 is a transverse section view of a harness according to a third embodiment of the invention; and

FIG. 7 is a transverse section view of a harness according to a fourth embodiment of the invention.

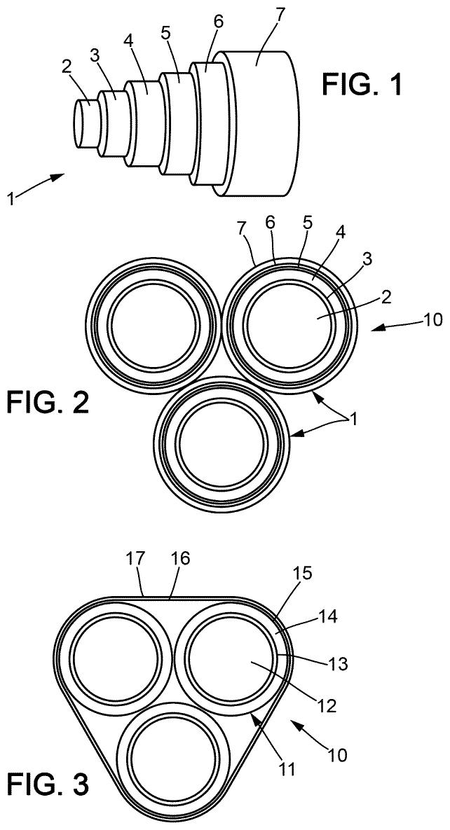

### DETAILED DESCRIPTION OF THE INVENTION

A power harness 10 for an aircraft according to the invention is shown in FIG. 3. The harness 10 comprises three cables 11 with coaxial structure comprising, radially from the interior to the exterior, a conducting core 12, an inner layer 13 of semiconductor material, an insulating layer 14 and an outer layer 15 of semiconductor material.

Unlike those from the prior art previously described, the cables 11 therefore do not comprise an individual shielding layer and protective jacket.

The three cables 11 are assembled in a twisted strand, with which to more easily keep an overall structure of the harness 10.

Alternatively, the cables may not be twisted and extend substantially parallel to each other.

A single, shared shielding layer 16 is placed around the three cables 11 in direct electrical contact with the outer layers 15 of the three cables 11.

This shared shielding layer 16 serves to assure that each of the outer layers 15 of the semiconductors are secured to ground.

The shielding layer 16 is sized to assure this securing to ground and, if needed, to provide the function of protection against electromagnetic waves, as a function of the number of cables, size thereof braiding angle, shielding type and semiconductor material type of the outer layer 15.

Such an arrangement with a shared shielding layer allows adding the induced currents generated by each of the cables of the harness and giving a zero-value resulting current for a balanced three-phase AC system.

In the case of a balanced three-phase PWM system, the resultant is the high-frequency current which is related to the switching of the power switches and which is intrinsic to the PWM system. Such a resulting induced current has a small amplitude and therefore has a greatly reduced impact compared to the state-of-the-art.

On FIG. 3, it can be seen that the semiconductor outer layers 15 are not in contact with the shielding layer 16 over the entirety of the circumference thereof.

To reduce possible radial potential differences in the harness 10, it is therefore advantageous to select a semiconductor material for the layers 15 having a low electrical resistivity.

For example, the semiconductor material making up the outer layers 15 has an electrical resistivity included between 10 Ωm and 100 Ω·m.

To assure an equipotential in the direction of extension of the harness 10, it is advantageous to select for the shielding layer 16 a material thickness such that the electrical resistance of the shielding layer 16 is included between 0.1 mΩ and 100 mΩ, preferably between 1 mΩ and 20 mΩ, and more preferably between 3 mΩ and 10 mΩ (recall that one milliohm mΩ is equal to 10⁻³ Ohm).

Advantageously a shared mechanical-protection jacket 17 radially surrounds the shielding layer 16.

The type of protection given by the jacket 17 depends on the conditions of use of the harness 10 (mechanical protection, airtightness, temperature resistance, etc.).

The jacket 17 may for example be a stainless steel or stainless steel microfilament jacket, a jacket braided of textile or polymer materials, a heat-shrink jacket, an extruded jacket, a wound-ribbon jacket, an overmolded jacket and a combination of several of the aforementioned jackets.

The arrangement of the cables 11 in a strand allows, if the cables 11 have a small section, a multichannel type connection on the equipment 20.

For cables 11 with a larger section then AWG 1 gauge, the use of single-channel connectors may be preferred.

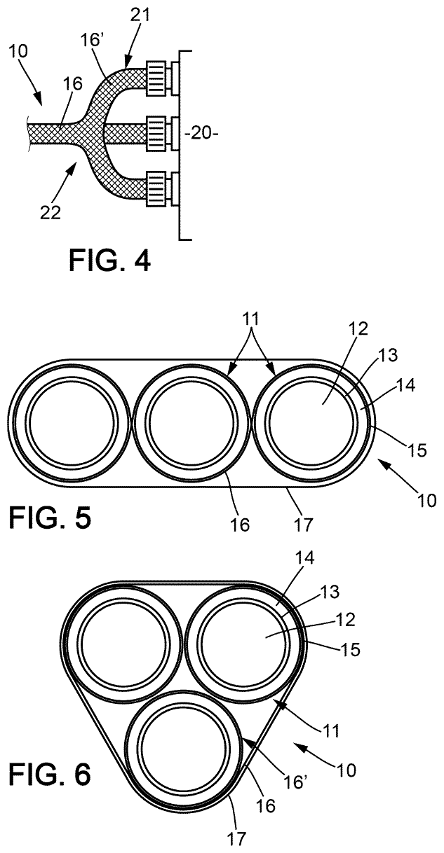

Such a connection point for the harness 10 to an equipment 20, with Y-type termination, is shown in FIG. 4.

The invention may also be applied similarly to terminal type connectors.

In the case shown, each of the cables 11 comprises an individual shielding 16′ on an end segment 21 of short length, near the ends 22 of the harness 10.

The losses generated in the Y-termination by the individual shielding will be limited because the corresponding end segments have short length, for example less than 50 cm.

Optionally, it is possible to further reduce the losses in the individual shielding by increasing the radial thickness of said individual shielding over the end segments only, for reducing the resistance thereof and therefore the Joule-effect losses.

It is also possible to add an electrical and thermal drain connected to the equipment structure 20 in order to avoid passage of current by the connector.

An embodiment of the harness 10 according to the invention is shown in FIG. 5 identical to the one previously described except for the following.

In the case of tight passages, the harness 10 can be made flat, over all or part of the length thereof. The cables 11 are then arranged aligned along a transverse direction of the harness 10.

The single, shared shielding layer 16 is then woven intercrossed around each of the cables 11 so as to have a substantially equal contact surface with each of the cables 11 in the harness 10. This serves to maintain a symmetry in the contact between the shielding layer 16 and each of the cables 11 and thus to minimize the intensity of the resulting induced current.

Such a shielding layer 16 is for example made from woven and/or braided conducting wires. A third embodiment of the harness according to the invention is shown on FIG. 6. This embodiment is identical to the first embodiment except for the following. Each of the cables 11 of the harness 10 comprises an individual shielding layer 16′, which adds to the shared shielding layer 16. Said shared shielding layer 16 is further placed in electrical contact with the individual shielding layers 16′ so as to assure electrical continuity and thus to minimize the induced currents as described above.

The harness 10 according to this third embodiment is more sensitive to vibrations (friction between the shielding) and heavier, but allows an electrical contact between the individual shielding layer 16′ and the entire periphery of each cable 11 of the harness 10.

The individual shielding layer 16′ of the cables may be implemented by a braiding which allows limiting the problem of wear by friction and forms a light shielding layer.

This third embodiment may be generalized to the harness made flat, with each cable 11 comprising an individual shielding layer 16′ and the harness comprising a shared shielding layer surrounding all the cables 11.

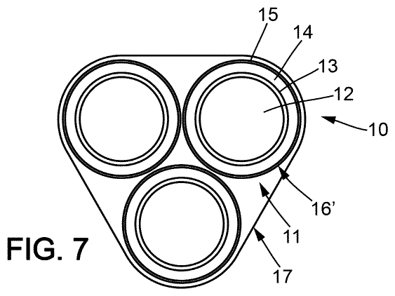

A fourth embodiment of the harness 10 according to the invention is shown on FIG. 7. In this embodiment, each cable 11 comprises an individual shielding layer 16′, where the individual shielding layers 16′ are arranged in permanent electrical contact with each other, so as to form a single shield from the electrical perspective.

The permanent electrical contact between the individual shielding layers 16′ is assured by tightening exerted by the protective jacket 17 which is for example a braided textile or polymer type jacket, a heat-shrunk jacket, an extruded jacket, a wound-ribbon jacket or an overmolded jacket.

1. An electric-power harness (10) for aircraft, comprising a plurality of cables (11), where each cable (11) comprises, radially from the inside to the outside:
a conducting core (12);
a first layer (13) of semiconductor material;
an insulating layer (14); and
a second layer (15) of semiconductor material;
wherein the harness (10) further comprises a shared shielding (16, 16′) placed in electrical contact with the second layers (15) of semiconductor material of each cable (11).

2. The harness (10) according to claim 1, wherein the harness (10) further comprises a protective jacket (17) arranged tightened radially around the shared shielding (16, 16′).

3. The harness (10) according to claim 2, wherein the shared shielding (16, 16′) is arranged in electrical contact with the second layer (15) of each cable (11) over a substantially equal contact surface for each of the cables (11).

4. The harness (10) according to claim 3, wherein the shared shielding (16, 16′) comprises a single shielding layer (16) placed radially around the cables (11) of the harness (10).

5. The harness (10) according to one claim 1, wherein each cable (11) comprises an individual shielding layer (16′), where the individual shielding layers (16′) are kept in mutual electrical contact.

6. The harness (10) according to claim 1, wherein the cables (11) are arranged substantially parallel to each other, aligned along a direction perpendicular to their principal elongation direction, where the shared shielding (16, 16′) is woven intercrossed around each of the cables (11).

7. The harness (10) according to claim 1, wherein electrical resistance of the shared shielding (16, 16′) between two ends of the harness (10) is between 0.1 mΩ and 100 mΩ.

8. The harness (10) according to claim 1, wherein the second layer of each cable is made of a semiconductor material having an electrical resistivity included between 10 Ω·m and 100 Ω·m.

9. The harness (10) according to claim 1, wherein, near at least one end (22) of the harness (10), each cable (11) comprises an individual shielding layer (16′) over an end segment (21).

10. The harness (10) according to claim 7, wherein electrical resistance of the shared shielding (16, 16′) between two ends of the harness (10) is between 1 mΩ and 20 mΩ.

11. The harness (10) according to claim 7, wherein electrical resistance of the shared shielding (16, 16′) between two ends of the harness (10) is between 3 mΩ and 10 mΩ.
